(19) United States
(12) Patent Application Publication
(10) Pub. No.: US 2016/0179601 A1
(43) Pub. Date: Jun. 23, 2016

(54) COMPUTING AND OBTAINING FAULT RELATED INFORMATION

(71) Applicant: EMC Corporation, Hopkinton, MA (US)

(72) Inventors: Chao Wu, Shanghai (CN); Li Zhai, Shanghai (CN); Sheng Mei, Shanghai (CN)

(21) Appl. No.: 14/968,360

(22) Filed: Dec. 14, 2015

(30) Foreign Application Priority Data
Dec. 19, 2014 (CN) 201410813707.4

(51) Int. Cl. G06F 11/07; H04W 84/12

(52) U.S. Cl. CPC G06F 11/079; G06F 11/0709; G06F 11/0751; G06F 11/0778; G06F 11/0787; H04W 84/12

(57) ABSTRACT

Embodiments of the present disclosure disclose a method, a computer program product and an apparatus for controlling sharing of resources among a plurality of nodes, wherein responsive to a service of using the resource to be initiated at a target node in the multiple nodes, locking a target file associated with use of the resource at the target node; responsive to the target file being successfully locked, determining, at the target node, whether other files associated with use of the resource at other nodes in the multiple nodes have been locked; in response to determining that the other files are not locked, initiating the service using the resource at the target node.

### RELATED APPLICATION

This application claims priority from Chinese Patent Application Number CN201410813707.4 filed on Dec. 19, 2014 entitled “COMPUTING DEVICE AND METHOD FOR OBTAINING FAULT RELATED INFORMATION” the content and teachings of which is herein incorporated by reference in its entirety.

### FIELD OF THE INVENTION

Embodiments of the present disclosure relate to information transmission.

### BACKGROUND OF THE INVENTION

During debugging of a computing device before delivery and its maintenance and use at a later time, it may usually be required to collect information related to the computing device. The term “computing device” used herein refers to a device having a computing capability, including, but not limited to, a server, a personal computer (PC), a laptop computer, a tablet computer, a personal digital assistant (PDA), a mobile telephone, a smart phone, and the like.

For example, when a computing device fails, it may be required to collect fault related information of the computing device, and then troubleshoot by analyzing the information. The term “fault related information” used herein refers to any suitable information available for fault analysis of a computing device and capable of reflecting a failure of a computing device, including, but not limited to, log information of the computing device. A common approach of collecting fault related information may be a manual on-site collection of an engineer. By way of example, an engineer may have to arrive at site and use a specific device (e.g., a laptop) to read log information from a dedicated port of a failed server via a dedicated data cable. It may be apparent that the cost of this approach may be very high, while its efficiency may be rather low.

### SUMMARY OF THE INVENTION

Embodiments of the present disclosure present a computing device and a method in a computing device for obtaining fault related information, wherein the computing device may include: a serial data transmission module configured to in response to a request for fault related information, obtain serial data indicating the fault related information; and a wireless communication module coupled to the serial data transmission module and configured to transmit the serial data via a wireless communication link.

### BRIEF DESCRIPTION OF THE ACCOMPANYING DRAWINGS

The above and other features, advantages and aspects of respective embodiments of the present disclosure will become more apparent by making references to the following detailed descriptions in conjunction with the accompanying drawings. In the accompanying drawings, the same or similar references refer to the same or similar elements, in which:

FIG. 1 shows an exemplary environment in which embodiments of the present disclosure may be implemented;

FIG. 2 shows an exemplary block diagram of a computing device according to one embodiment of the present disclosure;

FIG. 3 shows an exemplary flow diagram of a method for obtaining fault related information according to one embodiment of the present disclosure; and

FIG. 4 shows a block diagram of a computer system adapted for implementing the exemplary embodiments of the present disclosure.

### DETAILED DESCRIPTION

Hereinafter, embodiments of the present disclosure will be described in detail with reference to the accompanying drawings. Although some embodiments of the present disclosure have been illustrated in the accompanying drawings, it should be understood that the present disclosure may be implemented in various forms but not construed to be limited by embodiments described here. On the contrary, providing these embodiments is to make the present disclosure understood more thoroughly and completely. It should be understood that the accompanying drawings and embodiments of the present disclosure are merely for illustration without limiting the protection scope of the present disclosure.

The term “comprising” and its variations used here indicate an open inclusion, i.e., “including, but not limited to.” The term “based on” indicates “at least partially based on.” The term “one embodiment” indicates “at least one embodiment;” the term “another embodiment” indicates “at least a further embodiment.” Relevant definitions of other terms will be provided in the description below.

Embodiments of the present disclosure present a computing device and a method in a computing device for obtaining fault related information. In one embodiment, the computing device may include: a serial data transmission module configured to in response to a request for fault related information, obtain serial data indicating the fault related information. In a further embodiment, the computing device may include a wireless communication module coupled to the serial data transmission module and configured to transmit the serial data via a wireless communication link.

In one embodiment, there is provided a method implemented at least by a computing device for obtaining fault related information. A further embodiment may include, in response to a request for fault related information, obtaining serial data indicating the fault related information. A further embodiment may include transmitting the serial data via a wireless communication link.

Embodiments in this regard may further comprise a computer program product. In a further embodiment, the computer program product may be tangibly stored on a non-transient computer readable storage medium and may include a machine executable instruction, causing, when being executed, the machine to perform steps of the method disclosed above.

It would be appreciated through the following description that according to the embodiments of the present invention, fault related information of a computing device can be collected efficiently at a low cost

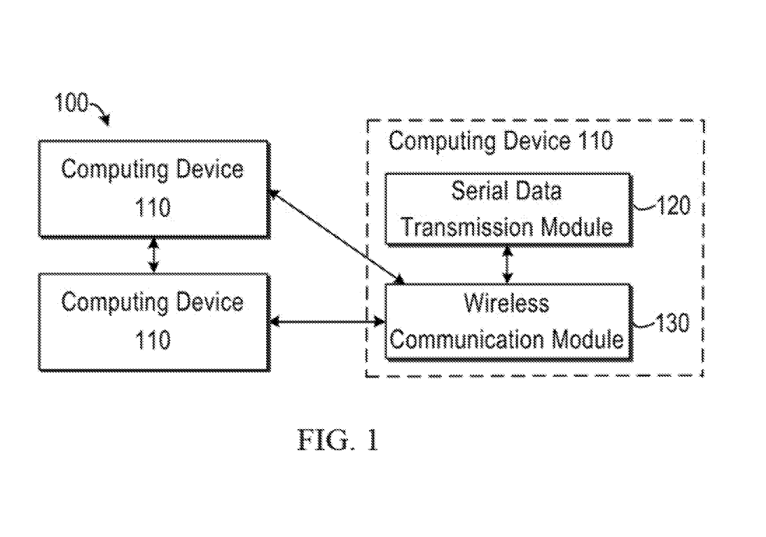

Reference is first made to FIG. 1, which shows exemplary environment 100, in which embodiments of the present disclosure may be implemented. As shown, environment 100 may generally comprise more computing devices 110 that may communicate with each other via a wireless communication link. It should be understood that the number of computing devices 110 as shown in FIG. 1 are only for purpose of illustration, without suggesting any limitation.

In some embodiment, examples of computing devices 110 may include, but are not limited to, one or more of the following: a server, a personal computer (PC), a laptop computer, a tablet computer, a personal digital assistant (PDA), a mobile phone, a smart phone, and the like.

In some embodiment, examples of a wireless communication link may include, but are not limited to, one or more of the following: a computer network link such as a wireless local area network (WAN) or a wireless fidelity (WiFi) and the like, a link of telecommunications network, such as 2G, 3G, 4G, or 4.5G, and Bluetooth, infrared, and the like.

It should be understood that although not shown in FIG. 1, computing device 110 may comprise: one or more processors or processing units, a memory, and a bus connecting different system components (including a processor or processing unit and a memory).

As shown in FIG. 1, in general, computing device 110 comprises a serial data transmission module 120 and a wireless communication module 130 coupled thereto. The term “couple” used herein comprises direct connection or indirect connection via an intermediate element. It should be understood that FIG. 1 only shows a schematic structure of one computing device 110; however, any computing device in environment 100 as shown in FIG. 1 has a similar structure.

Within the context of the embodiments of the present disclosure, the serial data transmission module refers to a port module adapted for serial data transmission. In some embodiment, examples of serial data transmission module may include, but may be not limited to, a universal asynchronous receiver/transmitter (UART) port module. It should be understood that the present disclosure may employ any known or future developed port module that may enable serial data transmission in the art, and the scope of the present disclosure is not limited in this regard. In certain embodiment, the wireless communication module refers to a module that can transmit data via a wireless communication link. In certain other embodiment, the wireless communication module may be implemented as any suitable module that can transmit data via any wireless communication link as described above. In certain other embodiments, examples of the wireless communication module may include, but may be not limited to, a Bluetooth module or a WiFi module.

According to the embodiments of the present disclosure in FIG. 1, serial data transmission module 120 in computing device 110 is configured to obtain serial data indicating fault related information in response to a request for the fault related information. Wireless communication module 130 is configured to transmit the serial data via the wireless communication link. As described above, in some embodiments, the fault related information may include any suitable information that may reflect a failure of a computing device. In some other embodiments, the data indicating fault related information may be any suitable data that may reflect a failure of a computing device. In some other embodiment, examples of the data may include, but may be not limited to, log data.

As described above with reference to FIG. 1, wireless communication module 130 may be any suitable module that can transmit data via any wireless communication link as described above. In one embodiment, when wireless communication module 130 may transmit serial data, wireless communication module 130 may directly send out the serial data obtained by serial data transmission module 120 via the wireless communication link. In an example embodiment, wireless communication module 130 may be a Bluetooth module, the serial data from serial data transmission module 120 may be directly sent outside computing device 110 via a Bluetooth link. In a further embodiment, since transmission distance of Bluetooth transmission may be short, interference between computing devices caused during data transmission may be relatively small.

In an alternate embodiment, when wireless communication module 130 is not adapted for serial data transmission, for example, when wireless communication module 130 may be a WiFi module, computing device 110 may also comprise a converting module that performs data format conversion between serial data transmission module 120 and wireless communication module 130. In a further embodiment, use of WiFi wireless transmission technology facilitates networking of computing devices, such that a plurality of computing devices may form a wireless network so as to communicate with each other wirelessly.

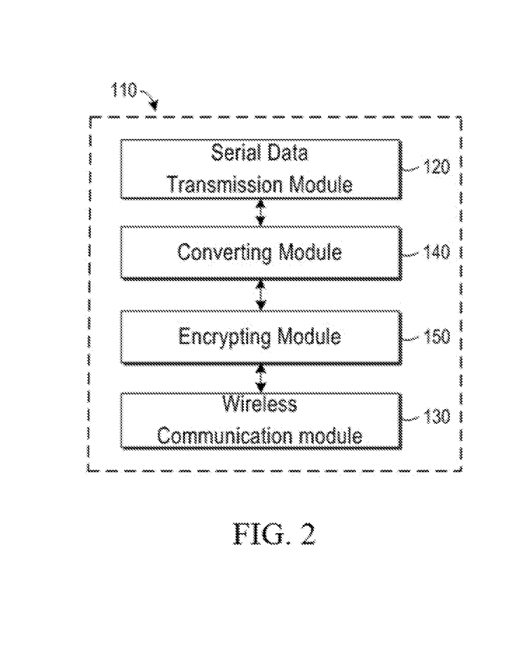

FIG. 2 shows an exemplary structure of such a computing device. As shown in FIG. 2, converting module 140 is coupled between serial data transmission module 120 and wireless communication module 130 and configured to convert the serial data obtained by serial data transmission module 120 into a format compatible with wireless communication module 130. Then, wireless communication module 130 may transmit data converted by converting module 140 via a wireless communication link. According to the embodiments of the present disclosure, converting module 140 may also perform reverse data format conversion, that is, convert the data received by wireless communication module 130 via the wireless communication link into serial data enabled by serial data transmission module 120.

As shown in FIG. 2, computing device 110 further comprises encrypting module 150. Encrypting module 150 may be configured to encrypt data before the data are transmitted via the wireless communication link. In one embodiment, a specific encrypting approach may be any known encrypting approach or future developed encrypting approach that may prevent data from being stolen, and the scope of the present invention may not be limited in this regard.

It should be understood that in one embodiment, converter module 140 may be integrated together with serial data transmission module 120 or wireless communication module 130, and encrypting module 150 may be integrated with wireless communication module 130. Alternatively, in another embodiment, converting module 140 and encrypting module 150 may be implemented as independent components separate from serial data transmission module 120 and wireless communication module 130. Other implementations are also possible.

Next, reference is continuously made to FIG. 1. According to the embodiments of the present disclosure, a request that triggers serial data transmission module 120 in computing device 110 to obtain the serial data indicating fault related information may be received in any suitable way. For example, in one embodiment, the request may be received by wireless communication module 130 via the wireless communication link. In a further embodiment, specifically, a request may be received from a device (e.g., a dedicated computing device) for collecting fault related information of individual computing devices via a wireless communication link. Alternatively, in another embodiment, a request may be manually input by a user such as an engineer performing fault analysis of a computing device. In a further embodiment, for example, a user may trigger a request by pressing down a certain physical button on a computing device.

According to the embodiments of the present disclosure, a requested fault related information may be fault related information of any computing device in environment 100. In one further embodiment, for example, trouble related information may be fault related information of a present computing device. In this example, serial data transmission module 120 in the computing device obtains data indicating fault related information of the present computing device in response to a request for fault related information of the present computing device. In this way, fault related information of individual computing devices in environment 100 may be collected in a wireless manner In a further embodiment, as described above, a conventional approach may need an engineer to manually collect fault related information using a cable. According to the embodiments of the present disclosure, fault related information of a computing device may be collected more efficiently.

Alternatively, in another embodiment, fault related information may also be fault related information of other computing devices in addition to the fault related information of a present computing device. In a further embodiment, correspondingly, wireless communication module 130 of a computing device may also be configured to receive via a wireless communication link data indicating fault related information of a further computing device. According to the embodiments of the present disclosure, wireless communication module 130 of the computing device may receive the data of fault related information of a further computing device at any suitable timing. In a further embodiment, for example, reception may be performed in response to a request for fault related information from a further computing device. In an alternate embodiment, wireless communication module 130 of the computing device may also receive corresponding fault related information from a further device in response to failure of the further computing device. In an alternate embodiment, wireless communication module 130 of a computing device may also periodically receive fault related information such as log from the further computing device.

In one embodiment, some computing devices in environment 100 may act as nodes collecting fault related information of individual computing devices and then corresponding fault related information may be obtained from the computing device for collecting fault related information in environment 100. In a further embodiment, in a conventional approach, an engineer has to manually collect fault related information of respective computing devices one by one. According to the embodiments of the present disclosure, fault related information may be transmitted between computing devices via a wireless communication link, which further enhances efficiency of collecting fault related information and may result in saving considerable human cost.

In some embodiments, for sake of clarity, FIG. 1 and FIG. 2 do not show some optional components included in computing device 110. In certain embodiments, it should be understood that individual components in computing device 110 may be hardware modules or software unit modules. For example, in some embodiments, serial data transmission module 120, wireless communication module 130, converting module 140 and encrypting module 150 may be partially or completely implemented using software and/or firmware. In some other embodiments, for example, these modules may be implemented as a computer program product embodied on a computer readable medium. In some other embodiments, alternatively or additionally, serial data transmission module 120, wireless communication module 130, converting module 140 and encrypting module 150 may be implemented partially or completely based on hardware. In some other embodiments, for example, these modules may be implemented as an integrated circuit (IC), a dedicated integrated circuit (ASIC), a system on chip (SOC), a field programmable gate array (FPGA), and the like. The scope of the present invention is not limited in this regard.

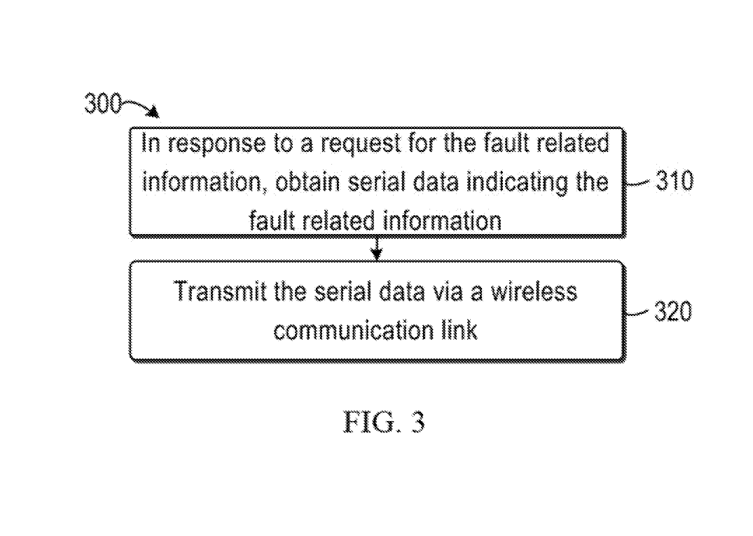

FIG. 3 shows ax exemplary flow chart of a method for obtaining fault related information according to one embodiment of the present disclosure. Method 300 may be implemented by computing device 110 as shown in FIGS. 1 and 2.

Method 300 starts from step 310 of in response to a request for fault related information, obtaining serial data indicating the fault related information. Then, in step 320, the serial data are transmitted via a wireless communication link. In one embodiment, the serial data follows a UART protocol.

In some embodiments, data may be transmitted via any wireless communication link as described above. In one embodiment, when a wireless communication enables serial data transmission, for example, when the wireless communication is Bluetooth communication, in step 320, serial data may be directly sent out via a wireless communication link. Alternatively, in another embodiment, when a wireless communication does not enable serial data transmission, for example, when the wireless communication is a WiFi communication, step 320 may comprises a step of data format conversion: converting serial data into a format compatible with a wireless communication, and then transmitting converted data via a wireless communication link.

According to the embodiments of the present disclosure, a requested fault related information may be fault related information of any computing device in environment 100. For example, in one embodiment, fault related information may be fault related information of a computer device itself that implements obtaining of fault related information.

Alternatively, in another embodiment, fault related information may be fault related information of a further computing device. In an example embodiment, method 300 may comprise receiving, via a wireless communication link, data indicating fault related information of a further computing device. As described above, according to the embodiments of the present disclosure, reception of data indicating fault related information of a further computing device may be performed at any suitable timing. For example, in one embodiment, reception may be performed in response to a request for fault related information of a further computing device. Alternatively, in one embodiment, in response to a failure of a further computing device, corresponding fault related information may be received from a further device. Otherwise, alternatively, in one embodiment, fault related information such as log may be periodically received from a further computing device.

It should be understood that steps in method 300 may be performed through computing devices 110 described with reference to FIGS. 1 and 2, respectively. Therefore, the features described above with reference to FIGS. 1 and 2 are likewise applicable to method 300 and achieve the same effect. The details will be omitted here.

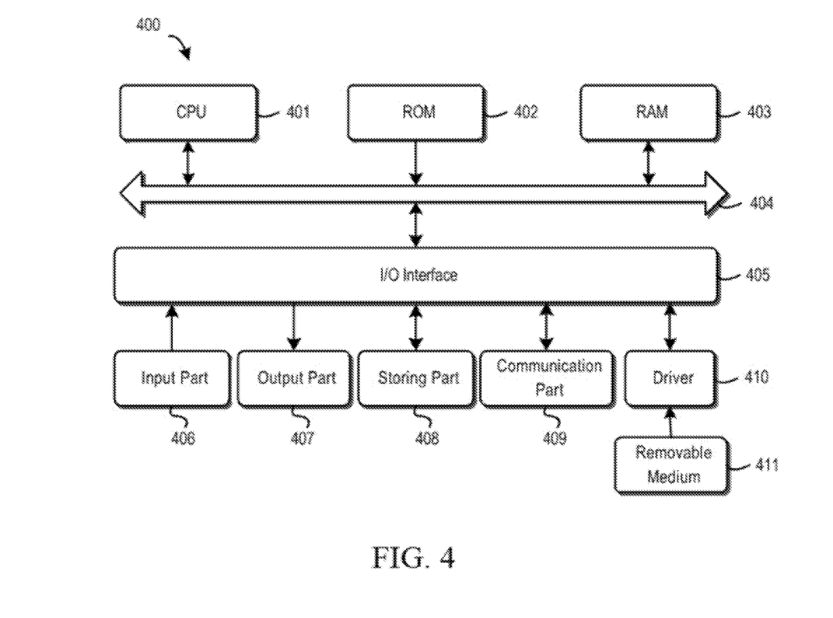

The present disclosure may be a device, a method, and/or a computer program product. Reference is made to FIG. 4, which shows a schematic block diagram of computer system 400 adapted for implementing the embodiments of the present invention. As shown in FIG. 4, computer system 400 comprises central processing unit (CPU) 401 that may perform various suitable actions and processing based on a program stored in read-only memory (ROM) 402 or a program loaded from storage part 408 to random access memory (RAM) 403. In RAM 403, there are further stored various programs and data needed for operations of device 400. CPU 401, ROM 402, and RAM 403 are connected to each other via bus 404. Input/output (I/O) interface 405 is also connected to bus 404.

The following components are connected to I/O interface 405: input part 406 including a keyboard, a mouse and the like; output part 407 including a cathode ray tube (CRT), a liquid crystal display (LCD) or the like, a speaker, and the like; storing part 408 including hard disk and the like; and communication part 409 including a network interface card such as a LAN card, a modem and the like. Communication part 409 performs communication processing over a network such as Internet. Driver 410 is also connected to I/O interface 405 as needed. Removable medium 411, such as a disk, an optical disk, a magneto-optical disk, a semiconductor memory, and the like, is mounted on driver 410 as needed such that a computer program read from thereon is installed into storing part 408 as needed.

In particular, according to the embodiments of the present disclosure, the process described with reference to FIGS. 1-3 may be implemented as a computer program product that can be tangibly stored on a non-transient computer readable medium and includes a machine executable instruction, causing, when being executed, the machine to implement various aspects of the present invention. In such an embodiment, computer program may be downloaded from a network via communicating part 409 and installed, and/or installed from removable medium 411.

The computer readable storage medium may be a tangible device that may store instructions used by an instruction execution device. The computer readable storage medium may include, but may be not limited to, for example, an electronic storage device, a magnetic storage device, an optical storage device, an electromagnetic storage device, a semiconductor storage device, or any suitable combination thereof. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination thereof. A computer readable storage medium, as used herein, is not to be construed as being transitory signals per se, such as radio waves or other electromagnetic waves freely propagating, electromagnetic waves propagating through a waveguide or other transmission media (e.g., light pulses passing through a fiber-optic cable), or electrical signals transmitted through a wire.

Computer program instructions for implementing operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, and the like, and conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on the remote computer or server. In the case involving the remote computer, the remote computer may be connected to the user's computer through any type of network, including a local area network (LAN) or a wide area network (WAN), or may be connected to an external computer (for example, through the Internet using an Internet Service Provider). In some embodiments, electronic circuitry, such as programmable logic circuitry, field-programmable gate arrays (FPGA), or programmable logic arrays (PLA), may be customized by utilizing state information of the computer readable program instructions, which may execute the computer readable program instructions in order to perform aspects of the present invention.

Aspects of the present disclosure are described herein with reference to flowcharts and/or block diagrams of the device, method, and computer program product according to embodiments of the present invention. It will be understood that each block of the flowcharts and/or block diagrams, and combinations of blocks in the flowcharts and/or block diagrams may be implemented by computer readable program instructions.

Various embodiments of the present disclosure have been described above for the purpose of illustration. However, the present disclosure is not intended to limit these embodiments as disclosed. Without departing from the essence of the present disclosure, all modifications and variations fall into the protection scope of the present disclosure defined by the claims.

What is claimed is:

1. A computing device, comprising:
a serial data transmission module configured to, in response to a request for a fault related information, obtain serial data indicating the fault related information; and
a wireless communication module coupled to the serial data transmission module and configured to transmit the serial data via a wireless communication link.

2. The computing device according to claim 1, wherein the fault related information comprises first fault related information of the computing device and second fault related information of a further computing device.

3. The computing device according to claim 2, wherein the wireless communication module is further configured to receive data indicating the second fault related information of the further computing device via the wireless communication link.

4. The computing device according to claim 3, further comprising:
a converting module configured to convert the serial data obtained by the serial data transmission module into a format compatible with the wireless communication module, and wherein the wireless communication module is further configured to transmit, via the wireless communication link, the serial data converted by the converting module.

5. The computing device according to claim 3, wherein the serial data transmission module comprises a universal asynchronous receiver/ transmitter (UART) module.

6. The computing device according claim 3, wherein the wireless communication module includes at least one of a Bluetooth module or a wireless fidelity (WiFi) module.

7. A method implemented by a computing device for obtaining fault related information, comprising:
in response to a request for a fault related information, obtaining serial data indicating the fault related information; and
transmitting the serial data via a wireless communication link.

8. The method according to claim 7, wherein the fault related information comprises first fault related information of the computing device and second fault related information of a further computing device.

9. The method according to claim 8, further comprising:
receiving data indicating the second fault related information of the further computing device via the wireless communication link.

10. The method according to claim 9, wherein transmitting the serial data via the wireless communication link comprises:
converting the serial data into a format compatible with wireless communication; and
transmitting the converted serial data via the wireless communication link.

11. The method according to claim 9, wherein the serial data follows a universal asynchronous receiver/transmitter (UART) protocol.

12. The method according claim 9, wherein the data transmitted via the wireless communication link includes at least one of a Bluetooth protocol or a wireless fidelity (WiFi) protocol.

13. A computer program product, the computer program product being tangibly stored on a non-transient computer readable storage medium and comprising a machine executable instruction that, when being executed, causes the machine to perform steps.
in response to a request for a fault related information, obtaining serial data indicating the fault related information; and
transmitting the serial data via a wireless communication link.

14. The computer program product according to claim 13, wherein the fault related information comprises first fault related information of the computing device and second fault related information of a further computing device.

15. The computer program product according to claim 14, further comprising:
receiving data indicating the second fault related information of the further computing device via the wireless communication link.

16. The computer program product according to claim 15, wherein transmitting the serial data via the wireless communication link comprises:
converting the serial data into a format compatible with wireless communication; and
transmitting the converted serial data via the wireless communication link.

17. The computer program product according to claim 15, wherein the serial data follows a universal asynchronous receiver/transmitter (UART) protocol.

18. The computer program product according claim 15, wherein the data transmitted via the wireless communication link includes at least one of a Bluetooth protocol or a wireless fidelity (WiFi) protocol.
